(19) United States
(12) Patent Application Publication
(10) Pub. No.: US 2012/0256511 A1
(43) Pub. Date: Oct. 11, 2012

(54) STATOR

(75) Inventor: Kentaro HARUNO, Toyota-shi (JP)

(73) Assignee: TOYOTA JIDOSHA KABUSHIKI KAISHA, Toyota-shi (JP)

(21) Appl. No.: 13/438,961

(22) Filed: Apr. 4, 2012

(30) Foreign Application Priority Data
Apr. 7, 2011 (JP) 2011-085730

(51) Int. Cl. H02K 3/34

(52) U.S. Cl. 310/215

(57) ABSTRACT

A stator includes a stator core that has at least one tooth which extends radially inward from the stator core and has a shape of a quadrangular prismoid, an insulator that is made of a resin, and a coil that is formed by winding a rectangular wire around the tooth via the insulator. The insulator has a thickness which varies depending on a relative positional relationship between the rectangular wire and the tooth, or the coil is formed in a staircase configuration to conform to the quadrangular prismoid shape of the tooth and the insulator has a varying thickness to conform to the staircase configuration.

### INCORPORATION BY REFERENCE

The disclosure of Japanese Patent Application No. 2011-085730 filed on Apr. 7, 2012 including the specification, drawings and abstract is incorporated herein by reference in its entirety.

### BACKGROUND OF THE INVENTION

1. Field of the Invention

The present invention relates to a motor that includes a stator that has teeth with the shape of a quadrangular prismoid which extend radially inward from a stator core and around which a rectangular wire is wound via a resin insulator.

2. Description of Related Art

In various types of motors, such as permanent magnet motor and induction motor, a plurality of phases of coils are wound around a stator to generate a rotating magnetic field. In other words, an annular stator core has a plurality of teeth that extend radially inward at equal intervals and coils are wound around the teeth. To reduce the size of a motor, the space factor of the coil in slots between the teeth (the occupancy of the wire in the slots) needs to be as large as possible. To accomplish this, the space in each slot, the insulating coating on the coils, the insulators that are provided between the teeth and the coils, and so on need to be as small as possible.

One possible solution is to reduce the thickness of the insulator as much as possible, to such an extent that its strength is not impaired. However, too small a thickness adversely affects the fluidity of the resin during molding, resulting in high possibility of occurrence of incomplete resin filling (short shot).

### SUMMARY OF THE INVENTION

The present invention provides a stator which can ensure sufficient fluidity of the resin that forms the insulators and a high filling rate (occupancy) of the coil in the slots. A first aspect of the present invention relates to a stator. The stator includes a stator core that has at least one tooth which extends radially inward from the stator core and has a shape of a quadrangular prismoid, an insulator that is made of a resin, and a coil that is formed by winding a rectangular wire around the tooth via the insulator, and the insulator has a thickness which varies depending on a relative positional relationship between the rectangular wire and the tooth.

In the stator, the thickness of a portion of the insulator at a location where a distance between the rectangular wire and the tooth is a first distance may be smaller than the thickness of a portion of the insulator at a location where a distance between the rectangular wire and the tooth is a second distance which is longer than the first distance.

A second aspect of the present invention relates to a stator. The stator includes a stator core that has at least one tooth which extends radially inward from the stator core and has a shape of a quadrangular prismoid, an insulator that is made of a resin, and a coil that is formed by winding a rectangular wire around the tooth via the insulator, and the coil is formed in a staircase configuration to conform to the quadrangular prismoid shape of the tooth, and the insulator has a varying thickness to conform to the staircase configuration.

In the stator, the thickness of portions of the insulator that are located in gaps between adjacent turns of the rectangular wire of the coil with the staircase configuration may be greater than the thickness of portions of the insulator that are located between flat portions of the adjacent turns of the rectangular wire of the coil and the tooth.

In the stator, the insulator may have a maximum thickness of 0.4 to 0.5 mm.

According to the first and second aspects of the present invention, the thick wall portions of the insulator ensure sufficient fluidity of the resin even if the other portions are less thick. Thus, the insulator can be substantially thinner to increase the filling rate of the coil (occupancy of copper in the slots).

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram that illustrates the configuration of a stator according to one embodiment;

FIG. 2 is a diagram that illustrates the configuration of an essential part;

FIG. 3 is a diagram that illustrates the configuration of an essential part of another embodiment; and

FIG. 4 is a schematic view that illustrates the configuration of a coil.

### DETAILED DESCRIPTION OF EMBODIMENTS

Description is hereinafter made of an embodiment of the present invention with reference to the drawings.

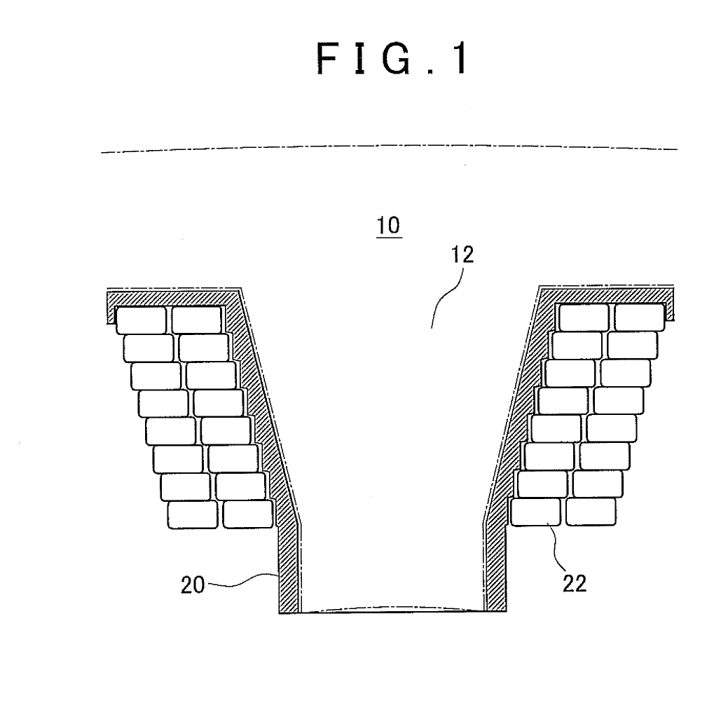

FIG. 1 shows the configuration of a tooth in teeth 12 of a stator. The stator that is shown by dot-and-dash lines in the drawing has the teeth 12 that extend radially inward from an annular stator core 10. The stator is composed of a magnetic steel sheet or a dust core. The teeth 12 have the shape of a quadrangular prismoid and gradually decrease in width inwardly. The length of the teeth 12 in the axial direction of the motor is the same throughout the stator.

Each of the teeth 12 is covered with a resin insulator 20, and a coil 22 is wound around each of the teeth 12 via the insulator 20. The insulators 20, which provide complete electrical insulation between the coils 22 and the teeth 12, are made of polyphenylene sulfide (PPS), for example. The insulators 20 are made to conform to the shape of one of the teeth 12 (i.e., a tooth) by molding a resin and fitted over the teeth 12.

Each coil 22, which is formed by winding a rectangular wire with a generally rectangular cross-section, has flat sides and corners. The coils 22 spirally surround the teeth 12 via the insulators 20. Because adjacent turns of the rectangular wire of each coil 22 are slightly offset from each other generally along the radial direction of the stator core 10 on both end faces of the teeth 12, the turns of the rectangular wire are tightly stacked to form a wall-like configuration in each gap (slot) between the teeth 12. Each coil 22 is formed of a rectangular copper wire that is coated with enamel.

Each insulator 20 covers both of the end faces of a tooth 12 generally along the direction in which the tooth 12 extends, and extends on both sides along the inner peripheral surface of the stator core 10 to cover halves of the bottoms of adjacent slots. In other words, the insulators 20 are disposed between the teeth 12 and the coils 22 that are wound around the teeth 12 and between the coils 22 and the stator core 10. The end faces of the teeth 12 on radially inside of the stator core 10 are opposed directly to the rotor. The portions of the insulators 20 that are disposed along the inner peripheral surface of the stator core 10 may extend on both sides of the tooth 12 to a position close to the center of the slots between the teeth 12 as shown in FIG. 1. Alternatively, each of the insulators 20 may have only a portion that extends along the inner peripheral surface of the stator core 10 to the base of one of the adjacent teeth 12 and may have no portion that extends along the inner peripheral surface of the stator core 10 to the base of another adjacent teeth 12.

The inner surfaces of the insulators 20 which cover the teeth 12 are almost flat so that they can firmly engage with the surfaces of the teeth 12, whereas the outer surfaces of the portions of the insulators 20 that cover the sides of the teeth 12 which gradually narrow toward the top (decreases in diameter toward the top) have a staircase configuration. In other words, the outer surfaces of the portions of the insulators 20 that cover the sides of the teeth 12 have a staircase configuration to conform to the sides of the rectangular-wire coils 22 which are opposed to the teeth 12.

This is described in more detail. Each coil 22 is formed by winding a rectangular wire such that adjacent turns form steps to conform to outer surfaces of the teeth 12 with the shape of a quadrangular prismoid and to have an uneven surface by the adjacent rectangular wires. Thus, in the inside of the coils 22, the flat portions of the rectangular wire are parallel to the shaft of the motor, but the turns of the rectangular wire gradually decrease in diameter. The insulators 20 have a varying thickness for each turn of the rectangular wire depending on the relative positional relationship between the rectangular wire and the tooth.

The thickness of the portions of the insulators 20 at locations where the distance between the inner surface of a turn of the rectangular wire and the tooth is relatively small is smaller than the thickness of the portions of the insulators 20 at locations where the distance between the rectangular wire and the tooth is relatively large.

In other words, the coils 22 are wound around the teeth 12 in a staircase configuration to conform to the teeth with the shape of a quadrangular prismoid. Thus, in the inner surfaces of the coils 22, the radial position of the inner flat surface of the rectangular wire is gradually shifted. The insulators 20 have a varying thickness to conform to the staircase configuration.

The formation of the thick wall portions of the insulators 20 ensures good fluidity of the resin during resin molding, leading to prevention of occurrence of incomplete resin filling (short shot) as a whole. In addition, the thick wall portions function as reinforcing ribs and maintain the strength of the insulators 20.

Specifically, the thinnest portions of the insulators 20 have a thickness of approximately 0.3 mm, and the thick wall portions have a thickness of 0.4 to 0.5 mm. In this case, occurrence of short shot during molding can be prevented without reducing the strength. Conventional insulators 20 have a thickness of approximately 0.5 mm, in which case the occupancy of the copper wire in a slot is approximately 55%. According to this embodiment, the same occupancy as that which is achieved when the insulators 20 have a thickness of 0.3 mm can be obtained, in which case the occupancy can be improved by approximately 2.5%.

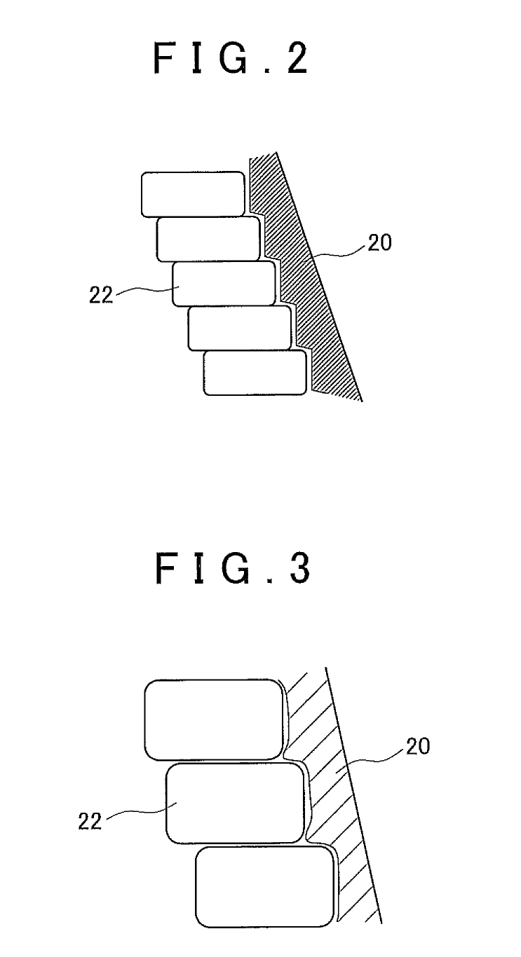

FIG. 2 is an enlarged view of a part where an insulator 20 and a coil 22 are in contact with each other. As shown in the drawing, the insulator 20 has thick wall portions to conform to the shape of the rectangular wire coil 22.

FIG. 3 shows an example of an insulator 20 which has protrusions which extend along the rounded corners of the turns of the rectangular wire on its outer surfaces. In this configuration, the thickness of the thick wall portions can be further increased.

Each turn of a coil 22 (rectangular wire) has a wound inner part which consists of a flat portion and chamfered portions on both sides of the flat portion in the axial direction of the teeth 12. Thus, in each coil 22, which has a plurality of turns, V-shaped gaps that open toward the outside of the rectangular wire (for example, radially inside of the teeth 12) are formed at locations where adjacent turns of the rectangular wire meet. In other words, a groove-like gap is formed between flat portions of adjacent turns of the rectangular wire. In the embodiment that is shown in FIG. 3, the thickness of the portions of the insulators 20 that are located in the gaps between adjacent turns of the coil 22 is greater than the thickness of the portions of the insulators 20 that are located between the flat portions of the turns of the rectangular wire and the teeth 12.

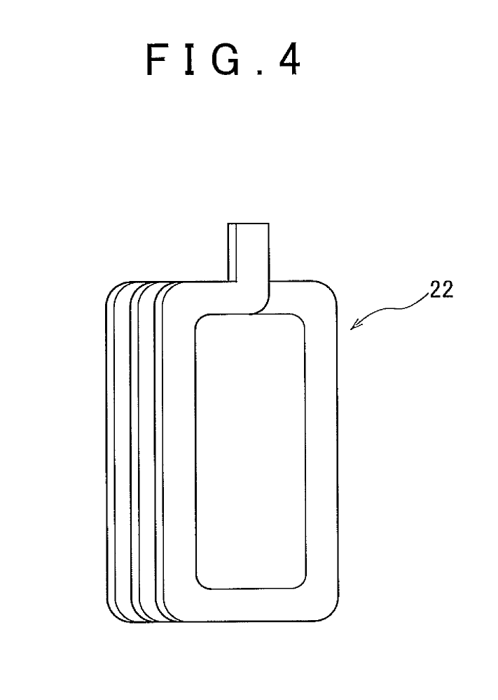

FIG. 4 shows a schematic view of a coil 22 that uses a rectangular wire. The diameter of the coil 22 gradually increases outward with increase in the width of the teeth 12 although it may be difficult to understand from FIG. 4.

In this embodiment, the teeth 12 are tapered inward. Thus, the coils 22 can be fitted over the teeth 12 from radially inside. In other words, when a stator that includes the stator core 10 and the teeth 12 is formed, the insulators 20 are fitted over the teeth. Then, the coils 22, which have been formed as windings as shown in FIG. 4, are fitted over the insulators 20 on the teeth 12. In this way, the stator can be produced. After the coils are mounted, the slots are filled with a resin. The connection between the coils 22 is made at the upper end of the stator.

Snap-fits which have a protrusion that is formed at an end of a leaf spring are formed on upper and lower end faces of each insulator 20, so that the end face of the coil 22 can be elastically retained by the snap-fits. In other words, the coil 22 advances pressing the snap-fits, and the snap-fits return when the inner ends of the coil 22 pass over the protrusions, whereby the inner end face of the coil 22 are held by the protrusions at the end of the leaf spring.

What is claimed is:

1. A stator comprising:
a stator core that has at least one tooth which extends radially inward from the stator core and has a shape of a quadrangular prismoid;
an insulator that is made of a resin; and
a coil that is formed by winding a rectangular wire around the tooth via the insulator,
wherein the insulator has a thickness which varies depending on a relative positional relationship between the rectangular wire and the tooth.

2. The stator according to claim 1,
wherein the thickness of a portion of the insulator at a location where a distance between the rectangular wire and the tooth is a first distance is smaller than the thickness of a portion of the insulator at a location where a distance between the rectangular wire and the tooth is a second distance which is longer than the first distance.

3. A stator comprising:
a stator core that has at least one tooth which extends radially inward from the stator core and has a shape of a quadrangular prismoid;
an insulator that is made of a resin; and
a coil that is formed by winding a rectangular wire around the tooth via the insulator,
wherein the coil is formed in a staircase configuration to conform to the quadrangular prismoid shape of the tooth, and the insulator has a varying thickness to conform to the staircase configuration.

4. The stator according to claim 3,
wherein the thickness of portions of the insulator that are located in gaps between adjacent turns of the rectangular wire of the coil with the staircase configuration is greater than the thickness of portions of the insulator that are located between flat portions of the adjacent turns of the rectangular wire of the coil and the tooth.

5. The stator according to claim 1,
wherein the insulator has a maximum thickness of 0.4 to 0.5 mm.
